(19) United States
(12) Patent Application Publication
(10) Pub. No.: US 2021/0347564 A1
(43) Pub. Date: Nov. 11, 2021

(54) TRANSPORTABLE CONTAINER WITH MATING ASSEMBLY FOR USE WITH A ROLL-OFF TRUCK

(71) Applicant: Gosnay Enterprises, Inc. d/b/a DFW Container Services, Plano, TX (US)

(72) Inventors: Carl GOSNAY, Plano, TX (US); John BLOOM, Addison, TX (US)

(73) Assignee: Gosnay Enterprises, Inc. d/b/a DFW Container Services, Plano, TX (US)

(21) Appl. No.: 17/443,329

(22) Filed: Jul. 24, 2021

Related U.S. Application Data
(63) Continuation of application No. 16/229,494, filed on Dec. 21, 2018.

(51) Int. Cl. B65D 90/00; B65D 88/12; B60P 1/64

(52) U.S. Cl. CPC B65D 90/0033; B65D 88/121; B60P 1/22; B60P 1/649; B60P 1/6427; B65D 88/129

(57) ABSTRACT

A transportable container includes: a container, wherein the container comprises: two sidewalls; a front wall; and a floor; and a mating assembly, wherein the mating assembly is attached to the container and comprises: two or more rails secured to an underneath plane of the floor, wherein the two or more rails matingly engage with two or more hoist rails of a roll-off truck; two or more rear rollers; and a loading assembly. The mating assembly and the loading assembly can be attached to the container after the container has been transported from a first location to a second location. The container can thus, be re-purposed for loading, transporting, and unloading via a roll-off truck. The container can be loaded, transported, and unloaded via a cable/winch system or a hook/lift system of the roll-off truck.

### TECHNICAL FIELD

A motor vehicle can be used to deliver and pick up a container, commonly called a roll-off container. The motor vehicle is commonly called a roll-off truck. The roll-off truck is designed to easily position the roll-off container onto a back end of the truck for transporting the container and easily unload the container at a desired location.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a side view of a container according to certain embodiments.

FIG. 2 is a bottom side perspective view of a container including rails and cross member supports according to certain embodiments.

FIG. 3 is a bottom view of the container of FIG. 2.

FIGS. 4 and 5 are front perspective views of the rails with a cable/winch assembly according to certain embodiments.

FIG. 6 is a rear perspective view of a motor vehicle for loading and unloading the container using a cable/winch system according to certain embodiments.

FIG. 7 is a front perspective view according to certain embodiments of a container for use with the loading and unloading system of FIG. 6.

FIGS. 8A-8F are side views of loading and unloading the container with the system of FIG. 6.

FIG. 9 is a front perspective view of a container for use with a hook/lift system according to certain other embodiments.

FIG. 10 is a side view of a motor vehicle for use with a hook/lift system of FIG. 9.

### DETAILED DESCRIPTION

Transportable containers are used to fill a variety of needs. The containers can be transported by a truck, commonly referred to in the industry as a roll-off truck. The roll-off truck is equipped with a specific means for loading, transporting, and unloading the container. Alternatively, a motor vehicle can be used with a trailer, wherein the trailer includes the specific means for loading, transporting, and unloading the container. As used herein, reference to a “roll-off truck” also includes a “roll-off trailer” without the need to continually specify the alternative throughout. The specific means can include a cable/winch system or a hook/lift system. A common type of container for use with a roll-off truck is called a roll-off dumpster. The roll-off dumpster can be delivered to a site, debris can be placed inside, and then loaded and transported to a dump site where the debris is discarded.

In order to be transportable with a roll-off truck, the container is also equipped with specific means that match the roll-off truck's cable/winch system or hook/lift system. In this manner, the container is able to be loaded, transported, and unloaded in an easy and economical fashion.

Unfortunately, there are many types of containers that are not adapted for use with a roll-off truck. One example of such a container is a cargo or shipping container, such as a conex box, a sea-land container, a storage container, etc. Other examples include portable offices, school rooms, and shelters. These containers generally include a floor that is flat; and thus, lack the necessary equipment, such as railings and wheels that would align with the roll-off truck's hoist system. Accordingly, these types of containers are not capable of being loaded, transported, and unloaded using a roll-off truck. Instead, these types of containers are typically loaded onto a flat bed of a truck using other means, such as a forklift or cable winch system most embodied on most flat-bed tow trucks.

However, there are tens of thousands of these types of containers that could be more easily transported using roll-off trucks with either a cable/winch system or a hook/lift system because of the ease of loading and unloading and the lower cost of using a roll-off truck instead of a flatbed truck and forklift. Moreover, there is a much lower risk of causing damage to the container when using a roll-off truck as opposed to a flatbed truck and forklift. By way of example, shipping containers are used to ship goods around the world. Once these containers arrive at the destination and are unloaded of the goods, the containers often remain in the destination country or city without being re-loaded of cargo and returned to the country of origin or another country. This situation can arise when there is a trade deficit between countries. Consequently, these containers can be re-purposed for use as a dumpster, office space, laboratory, school house, or even temporary shelters for people. Thus, there is a need and an ongoing industry-wide concern to adapt these types of containers for use with a roll-off truck.

It has been discovered that one or more components can be attached to the floor of a container. The components can include for example, rails, cross member supports, rear rollers, loading assemblies, or combinations thereof whereby the container can now be loaded, transported, and unloaded via a roll-off truck. The roll-off truck can include a system for easily loading and unloading the modified container. Such a system can include, for example, a cable/winch system or a hook/lift system. In this manner, the container can now be transported in a simple, efficient, cost-effective, and less damaging manner.

According to certain embodiments, a transportable container comprises: a container, wherein the container comprises: two sidewalls; a front wall; and a floor; and a mating assembly, wherein the mating assembly is attached to the container and comprises: two or more rails secured to an underneath plane of the floor, wherein the two or more rails matingly engage with two or more hoist rails of a roll-off truck; two or more rear rollers; and a loading assembly.

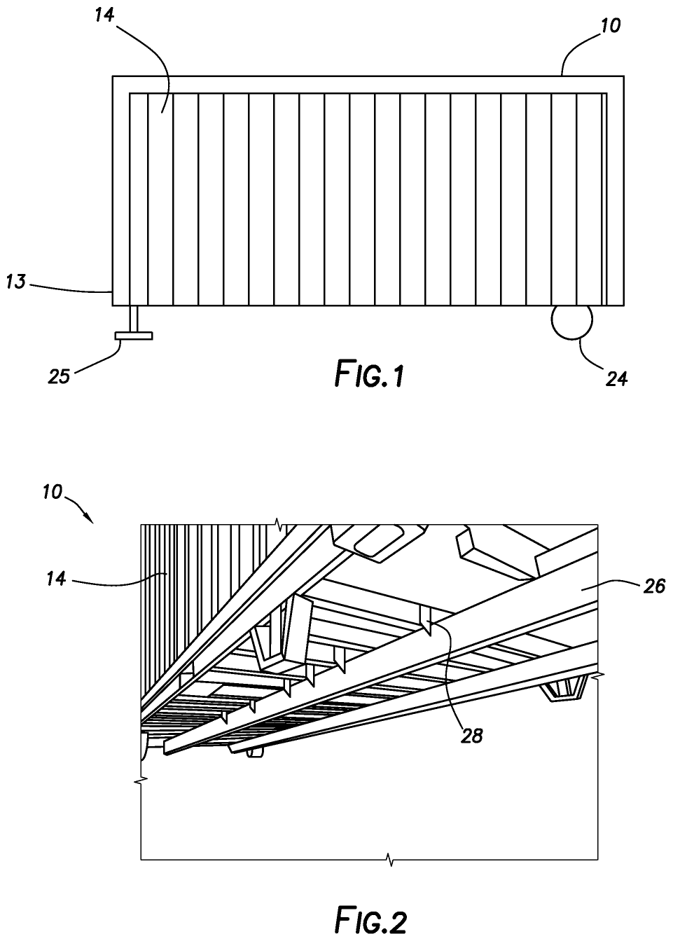

Turning to the figures, FIG. 1 is a perspective view of a transportable container 10 according to certain embodiments. As used herein, the “container” is any type of container that is not designed to be loaded, transported, and unloaded using a roll-off truck. It is to be understood that the mating assembly is added to the container and is not part of the container manufacturing process (i.e., the container does not include the rails, rear rollers, loading assembly, and optionally the cross member supports at the conclusion of the container's manufacturing process). Thus, the mating assembly is attached to the container such that the container can be re-purposed to be used with a roll-off truck. The container 10 includes two or more sidewalls 14, a front wall 13, and a floor 15.

The container 10 can have an open top, for example, when the container 10 is used as a dumpster, or the container 10 can include a roof (not shown). The roof can be a variety of geometric shapes, such as a flat rectangular roof, an angled roof, or a triangular-shaped roof. A roof may be advantageous when the container 10 is used as a shelter, office, school, or workspace. The container 10 can also include a back wall (not shown). The back wall can open or be permanently closed. For a back wall that opens, the back wall can be hinged along one edge to a corresponding edge of a side wall. In this manner, the back wall can be opened and closed via the hinges. The back wall can further include a latch for securing the back wall to an edge of the side wall opposite of the hinges for securing the back wall in a closed/locked position. The back wall can further include an anchor at a bottom of the back wall for temporarily securing the back wall in an open position. The container 10 can also include one or more doors and/or windows. This embodiment may be useful when the container 10 is used as a shelter, office, school, or workspace, for example.

The container 10 can further include two or more legs 25 located near the front wall of the container. The legs 25 can be height adjustable. Adjustable legs 25 can be in a retracted position during loading and unloading of the container 10 and in an expanded position during use. The height of the adjustable legs 25 can be adjusted to provide a relatively level floor of the container 10.

The container 10 can be made from a variety of materials including, but not limited to, metals, metal alloys, non-flexible plastics, wood materials, sheetrock, and combinations thereof. The container 10 can also have a variety of dimensions. According to certain embodiments, the dimensions of the container 10 are selected such that the container 10 is capable of being loaded, transported, and unloaded using a roll-off truck. According to certain other embodiments, the container 10 has length dimensions in the range of about 1 feet (ft) (0.3 meters (m)) to about 45 ft (13.7 m), width dimensions in the range of about 5 ft (1.5 m) to about 10 ft (3.0 m), and height dimensions in the range of about 1 ft (0.3 m) to about 15 ft (4.6 m).

As used herein, the term “transportable” means the ability to be loaded onto a back of a roll-off truck, moved to another location via the roll-off truck, and unloaded from the back of the roll-off truck, truck bed, or roll-off trailer. As used herein, the term “container” means any device that can hold items or people.

The container can be, without limitation, a dumpster or a building (e.g., an office space, school, living quarters, or shelter). Non-limiting examples of containers include storage containers, portable offices, portable laboratories, generators, conex boxes, connex boxes, shipping containers, sheds, construction site containers, equipment storage modified containers, office containers, delivery containers, sea train containers, storage boxes, cargo containers, refrigerated containers, insulated containers, ocean containers, wind and watertight containers, refurbished containers, livestock or animal shelters, portable workshops, tool shops, guard shacks, and shelters for humans and/or animals.

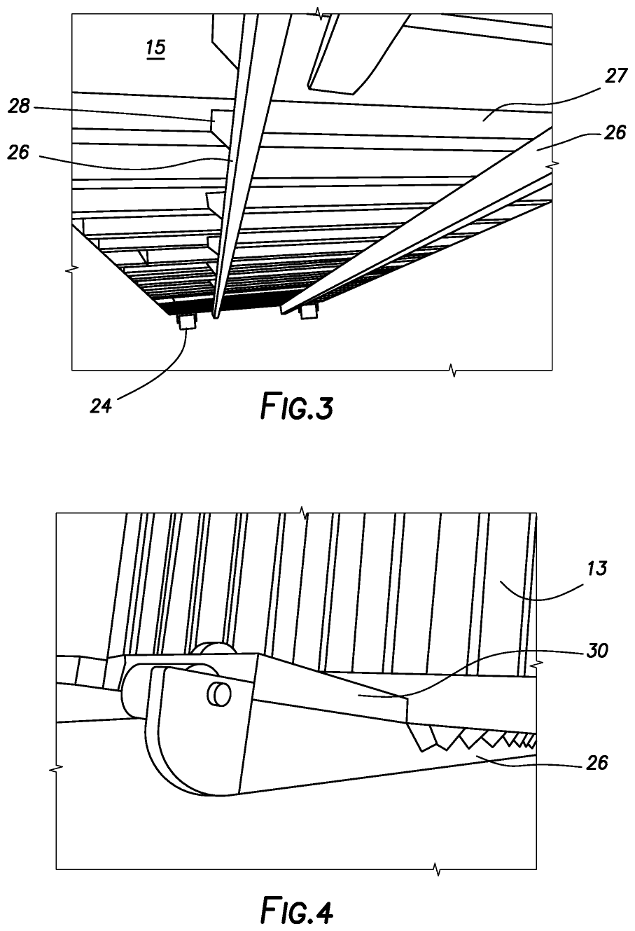

FIGS. 2 and 3 show an underneath side of the container 10 including the mating assembly for use with a roll-off truck. As used herein, the “mating assembly” means one or more components that are attached to the container in order to enable the container to be loaded, transported, and unloaded via a roll-off truck. According to certain embodiments, the components of the mating assembly are made from structurally sturdy materials, for example, metals or metal alloys. It is to be understood that the container is not manufactured with the mating assembly and loading assembly, but rather, the mating and loading assemblies are attached to the container at a later date. According to certain preferred embodiments, the mating assembly and the loading assembly are attached to the container after the container has been shipped from a first location to a second location. In this manner, the container can be re-purposed for loading, transporting, and unloading via either of the systems described below (i.e., a cable/winch system or a hook/lift system).

According to certain embodiments, the mating assembly includes two or more rails 26. The rails 26 can be outside rails, inside rails, or guides. Although shown with only two rails 26, the mating assembly can also include more than two rails. By way of example, the container 10 can include outside rails and inside rails. The two or more rails 26 matingly engage with two or more hoist rails of a roll-off truck. The phrase “roll-off truck” is a common phrase in the industry that one of ordinary skill in the art will understand to mean a motor vehicle or trailer that utilizes a system (e.g., a cable/winch or a hook/lift) for loading, transporting, and unloading a roll-off container. The two or more rails 26 can be secured to an underneath plane of the floor 15 of the container 10. Accordingly, the container does not already include the two or more rails 26, but rather the two or more rails 26 are secured to the underneath plane of the floor 15 specifically to allow the container 10 to be transported via a roll-off truck. The two or more rails 26 are secured to the underneath plane of the floor wherein the rails are located parallel to the length of the two or more sidewalls 14 of the container 10 and perpendicular to the front wall 13.

According to certain embodiments, the container 10 already includes two or more cross member supports 27. That is, the container 10 is manufactured with the cross member supports 27. According to certain other embodiments, the container 10 does not already include the cross member supports 27. According to this embodiment, the mating assembly further includes two or more cross member supports 27 that are secured to the underneath plane of the floor. The cross member supports 27 are positioned in a direction that is perpendicular to the two or more side walls 14 and parallel to a front wall 13 of the container. The cross member supports 27 can span the entire width or substantially the entire width of the floor 15.

The two or more rails 26 can be secured to the underneath plane of the floor 15 by securing the rails to the two or more cross member supports 27. The two or more rails 26 can be secured to the cross member supports 27 by a variety of mechanisms including, but not limited to, spot welding, or bolts and nuts for example, when the container is made from a plastic as opposed to a metal. The mating assembly can further include multiple gussets 28 for securing the two or more rails 26 to the two or more cross member supports 27.

The mating assembly also includes two or more rear rollers 24. The rear rollers 24 in FIG. 3 are depicted at the back of the container 10. The rear rollers 24 enable the container 10 to be loaded and unloaded from the roll-off truck. The rear rollers 24 can be positioned in any location on the underneath side of the container 10 to enable the container 10 to move via the rear rollers onto the back of the roll-off truck and assist with proper alignment.

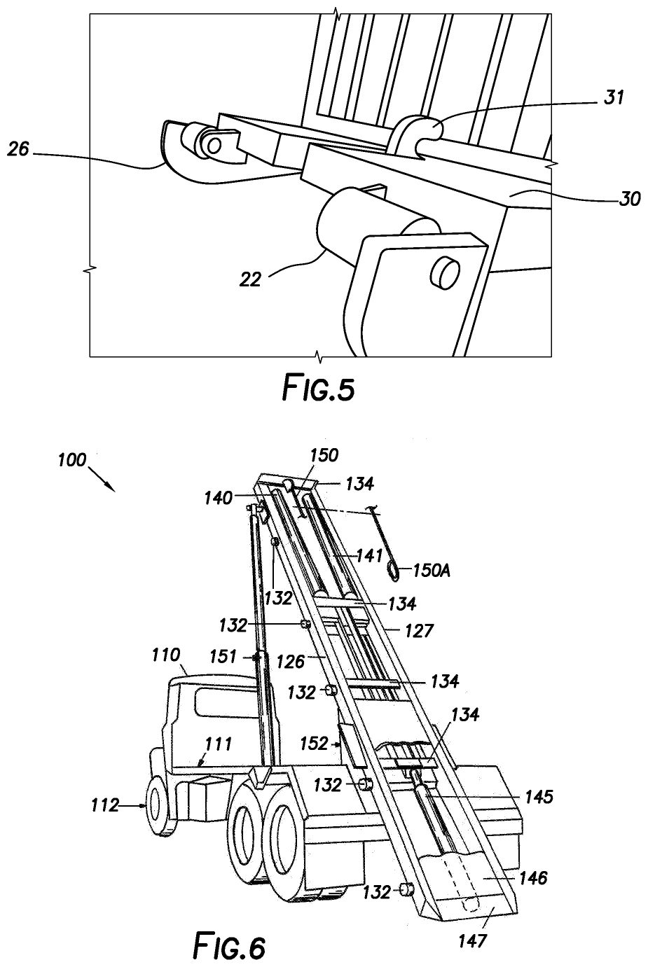

The mating assembly also includes a loading assembly. The loading assembly can be secured to the two or more rails 26 and optionally the front wall 13 of the container 10. FIGS. 3 and 4 show a loading assembly according to certain embodiments. According to these embodiments, the loading assembly is for use with a cable/winch system of a roll-off truck. According to these embodiments, the loading assembly includes a hook plate 30, a hook 31, and two front rollers 22. According to these embodiments, the two or more rails 26 extend out from the front wall 13 of the container 10. The hook plate 30 can include a recessed portion that aligns with the hook 31 for use with a cable/winch system of the roll-off truck. The front rollers 22 can be positioned at the front end of the two or more rails 26. The front rollers 22 can also enable the two or more rails 26 to matingly engage with hoist rails of the roll-off truck. Instead of, or in addition to, the front rollers 22, the mating assembly can also include two or more bottom rollers located on the underneath side of the floor 15 at a front end of the floor. These bottom rollers can help enable the mating engagement of the two or more rails 26 and/or enable the floor of the container 10 to be level.

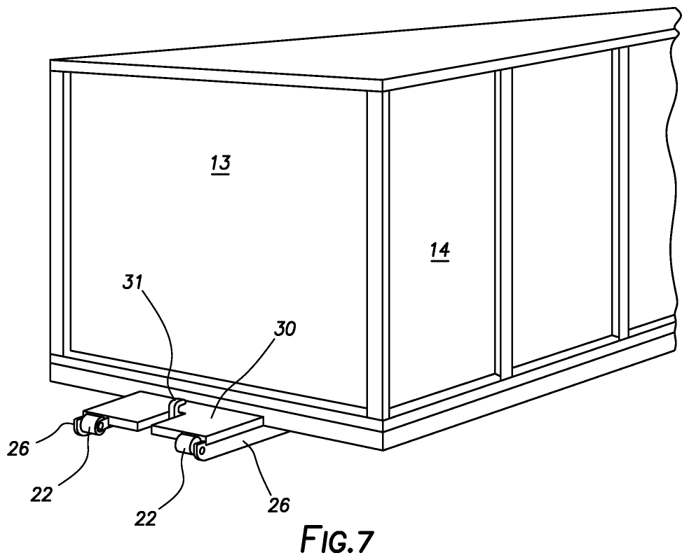

FIG. 6 shows a roll-off truck 100 according to certain embodiments. The roll-off truck 100 can include a system for loading, transporting, and unloading the container 10. The system can be any system that utilizes two or more hoist frames located on the roll-off truck 100 that matingly engage with the two or more rails 26 of the mating assembly. According to certain embodiments and as depicted in FIG. 6, the system can be a cable/winch system.

The roll-off truck 100 can include a driver's cab 110 on the forward part of a chassis frame 111 that is supported by conventional, steerable front wheel assemblies 112. The rear portion of the chassis frame 111 can be supported by tandem drive wheel assemblies. Other forms of vehicles can be utilized. For example, a trailer having a fifth wheel by which the trailer is driven and controlled by a tractor can be used. A carrier can extend forwardly toward the cab 110 from the hinge bar between parallel and spaced-apart hoist rails 126 and 127, which can form part of a hoist frame. At each spaced-apart location on the outsides of the hoist rails 126 and 127 can be rollers 132 supported on an arbor to matingly engage with the rails 26 of the subfloor 20. Cross braces 134 can tie the hoist rails 126 and 127 together to prevent their movement toward or away from each other. Housing assemblies can form two longitudinal chambers to slideably receive sheave blocks that are mounted on the rod ends of winch cylinders 140 and 141, respectively.

A tie plate can interconnect plates at the top of the housing assemblies and form an elongated chamber between wherein the rod end of a piston and cylinder assembly 145 is protectively housed when the piston is extended from the cylinder portion. A guard plate 146 can extend between the hoist rails 126 and 127 above the housing assemblies and from a ramp 147, which is welded to the hoist rails 126 and 127, to a point forward from a hinge pin. The guard plate 146 can extend forwardly along the hoist to protectively cover the piston and cylinder assembly 145, when fully extended, to prevent damage that might otherwise occur in the event of a derailment of the container 10 and subfloor 20 during loading and unloading operations on the hoist. The cylinder portion of the piston and cylinder assembly 145 can be flange-mounted to an end wall of a cross-member forming ramp 147. The rod end of the piston and cylinder assembly 145 can be mounted by a clevis pin extending through a clevis end of the piston rod and through a clevis support, which is secured to the slide carrier. A cable 150 can be anchored at one end to a hoist rail and trained about a system of pulleys that includes a sheave and bocks in a manner known in the art, so that a hook 150A on the free end of the cable can be drawn along the length of the hoist rails 126 and 127.

Hoist rails 126 and 127 can extend from the ramp 147 forwardly beyond the plane of a pivot shaft along the sub frame on the chassis frame 111 to a point that is about 6 inches from the back of the driver's cab 110. Connected to the sides of the forward portion of the hoist rails 126 and 127 are the rod ends of piston and cylinder assemblies 151 and 152, which are pivotally mounted at their cylinder ends by brackets to the chassis frame 111 of the roll-off truck 100. The piston and cylinder assemblies 151 and 152 can link the forward portion of the hoist rails 126 and 127 to the chassis frame 111 so that the rails jut from the roll-off truck 100 for loading or unloading the container 10 and subfloor 20.

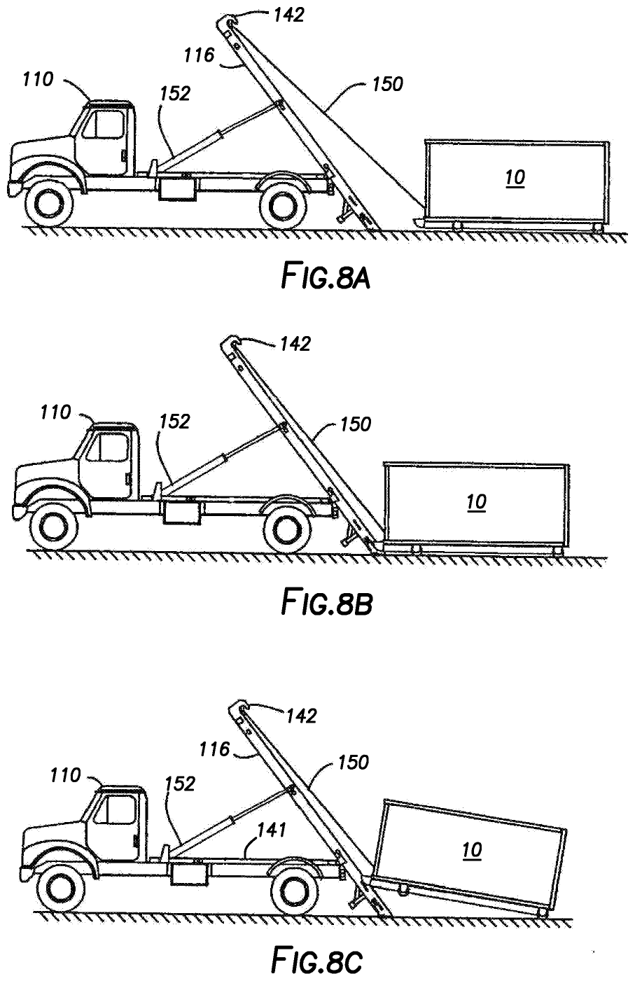

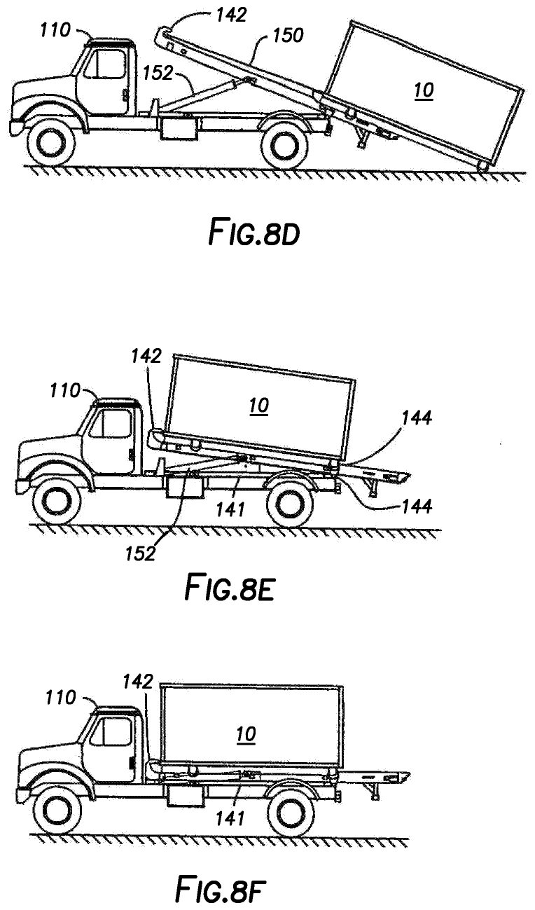

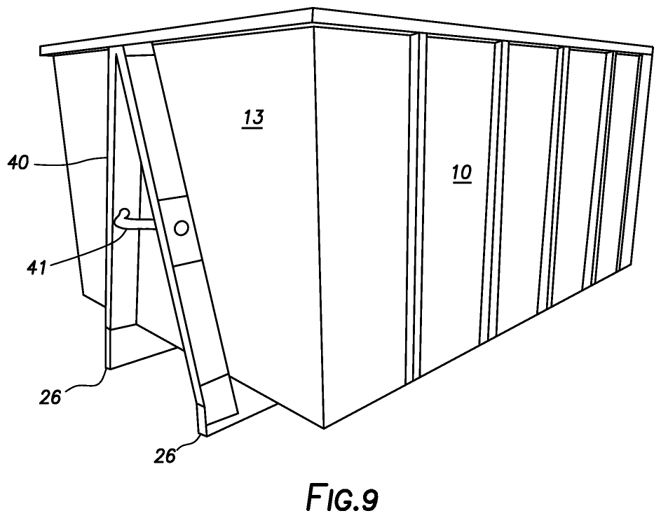

FIG. 8A-8F depict loading of the container 10 onto the back of the roll-off truck 100 using the cable/winch system. The roll-off truck 100 can include a top frame 116 that can preferably include a top frame hinge assembly 144 and a sub-frame preferably includes a sub-frame hinge assembly that are adapted to engage one another to provide the capability of pivotal movement of the top frame 116 with respect to the sub-frame between the horizontal or transporting position and the upwardly inclined loading and/or unloading position. The sub-frame can include a saddle 142 to further facilitate receiving of a front section of the container 10.

For loading, the hook 150 is secured to the hook 31. The cable is then powered by a source of power and hydraulic fluid to engage the piston and cylinder assemblies 145, 151, and 152. The length of the cable is decreased whereby a front of the container 10 is moved towards the ramp 147. The front and back rollers 24 of the subfloor can aid movement of the container 10. As the container 10 moves forward, the rails 26 of the subfloor 20 become aligned with the hoist rails 126 and 127. The rails 26 then matingly engage the hoist rails 126 and 127 to align and move the container 10 onto the bed of the roll-off truck 100. The rails 26 continue the mating engagement and slide alongside the hoist rails 126 and 127 during loading and unloading. After loading is complete, the top frame 116 will be parallel with the chassis frame 111. The roll-off truck 100 and container 10 can further include a locking mechanism (not shown) for securing the container 10 to the bed of the roll-off truck 100 during transportation.

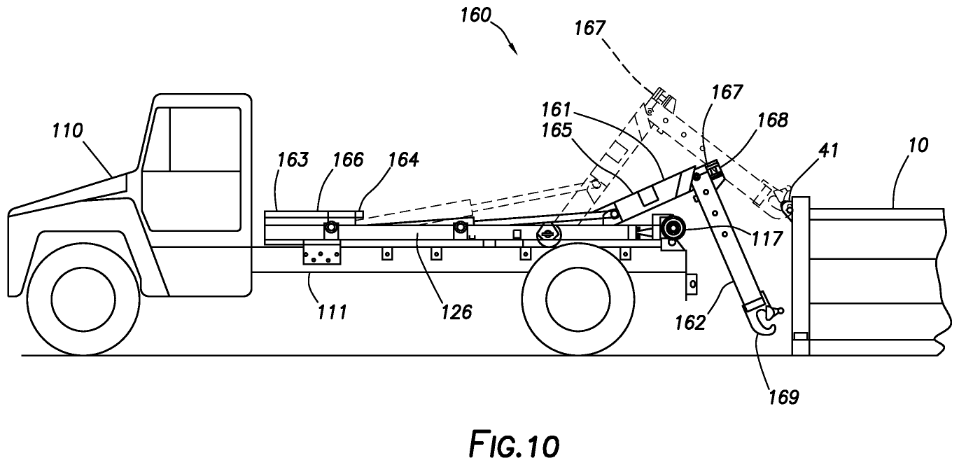

FIG. 9 depicts a loading assembly according to other certain embodiments. These embodiments are for use with a hook/lift system of a roll-off truck. According to these embodiments, the loading assembly includes a frame 40, commonly referred to in the industry as an A-frame, with a cross-bar 41 spanning between two parts of the frame. The cross-bar 41 can have a variety of shapes including, but not limited to, triangular, U-shaped, and semi-circular and be made of any material that provides structural integrity to the frame and cross-member. The bottom portions of the frame 40 can be attached to the front portion of the two or more rails 26 and attached to the front wall 13 of the container 10 at the apex of the frame 40. The frame 40 can be attached to the two or more rails 26 and front wall 13 via, for example, welding, spot welding, or fasteners.

FIG. 10 depicts a roll-off truck 100 utilizing the hook/lift assembly 160. As shown, the roll-off truck 100 can include a sub-frame, a tilt frame, a lift arm 167, left and right hydraulic actuators, lift arm latch 168, and a pair of tilt frame coupling members or ring locks. The sub-frame is fixedly secured to the chassis frame 111, the tilt frame is pivotally connected to the sub-frame at their respective rear ends, and the lift arm 167 is pivotally connected to the tilt frame. The lift arm latch 168 releasably connects the lift arm 167 to the tilt frame to prevent the lift arm from pivoting relative to the tilt frame when the tilt frame is pivoted relative to the chassis frame 111. The tilt frame ring locks releasably connect or tie the tilt frame to the chassis frame 111 to selectively prevent the tilt frame from pivoting relative to the chassis frame 111 and to distribute the load exerted on the tilt frame by the lift arm 167 to the chassis frame 111, when the lift arm is used to lift a container 10.

The sub-frame includes parallel extending hoist rails 126 and 127, which are fixedly connected to left and right main frame beams respectively by bolting, clamping, welding or the like. The lift arm 167 is generally L-shaped and includes a first leg 161 connected to and extending perpendicular to a second leg 162. The first leg 161 is further formed from an inner section telescopically mounted within an outer section or outer boom 165. An outer end of the inner section is connected to the second leg 162 and collectively the inner section of first leg 161 and second leg 162 may be referred to as the inner boom. A hydraulic actuator connected between the inner section and outer boom 165 is used to selectively extend and retract the inner boom relative to the outer boom 165 through controls (not shown) provided on the roll-off truck 100. The lift arm latch 168 is mounted on the inner boom at the corner between the first and second legs 161 and 162. As the inner boom is extended toward the front of the roll-off truck 100, with the lift arm 167 in the pivotally retracted position, the lift arm latch 168 engages a lift arm latch receiver 166 mounted to the tilt frame between the hoist rails 126 and 127 to latch or lock the lift arm 167 to the tilt frame. The latch receiver 166 is formed by a pair of inwardly facing channel members connected to the hoist rails 126 and 127 by struts. The channel members extend between and parallel to the hoist rails 126 and 127 from the front end of the tilt frame to a position just short of the space occupied by the lift arm latch 168 when the lift arm is in the pivotally retracted position and the inner boom is fully retracted.

Horizontal guide members 164 help guide the inner boom and the lift arm latch 168 into a receiver channel and slot. If the inner boom is extended relative to the outer boom 165 to a sufficient degree as the lift arm 167 is pivoted toward its retracted position, the outer edges of the pivotal latch members will engage the vertical guide members 163 of channel members to help maintain vertical position of the container 10. A container coupling member or hook 169 is formed on the free end of the second leg 162 opposite the first leg 161. The hook 169 engages the cross-bar 41 of the frame 40 to permit movement of the container 10 by the lift arm 167. The hook 169 is secured to the cross-bar 41 to load the container 10 onto the bed of the roll-off truck 100. As with the cable/winch system, movement of the container 10 towards a read end of the roll-off truck 100 occurs as the lift arm 167 is engaged, whereby the rails 26 matingly engage with hoist rails 126 and 127. A roller bar 117 can facilitate loading and unloading of the container 10.

Loading and unloading of the container 10 onto and off of the bed of the roll-off truck 100 can occur with the inner boom retracted relative to the outer boom 165. After the container 10 has been pulled up and matingly engages with the hoist rails 126 and 127 by pivoting the lift arm 167 to the retracted or loaded position, the container 10 can be moved further onto the hoist rails 126 and 127 and toward the cab 110 of the roll-off truck 100 by extending the inner boom relative to the outer boom 165 through extension of a boom extension actuator.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more rails, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of converting a container to a transportable container comprising:
providing a container, wherein the container comprises:
two sidewalls;
a front wall; and
a floor, wherein the two sidewalls, the front wall, and the floor are structural components of the container;
transporting the container from a first location to a second location; and
attaching a mating assembly to the container to provide a transportable container,
wherein the mating assembly comprises:
two or more rails directly secured to an underneath plane of the floor, wherein the two or more rails matingly engage with two or more hoist rails of a roll-off truck;
two or more rear rollers; and
a loading assembly.

2. The method according to claim 1, wherein the two or more rails are outside rails, inside rails, or guides.

3. The method according to claim 1, wherein the mating assembly further comprises one or more front rollers positioned at a front end of the two or more rails.

4. The method according to claim 1, wherein the container further comprises two or more legs attached to the underneath plane of the floor and located near the front wall of the container.

5. The method according to claim 4, wherein the two or more legs are height adjustable.

6. The method according to claim 1, wherein the container has an open top or further comprises a roof.

7. The method according to claim 1, wherein the container has length dimensions in the range of about 1 feet to about 45 feet, width dimensions in the range of about 5 feet to about 10 feet, and height dimensions in the range of about 1 feet to about 15 feet.

8. The method according to claim 1, wherein the container is made from materials selected from the group consisting of metals, metal alloys, non-flexible plastics, wood materials, sheetrock, and combinations thereof.

9. The method according to claim 1, wherein the mating assembly further comprises two or more cross member supports, and wherein the two or more cross member supports are secured to the underneath plane of the floor.

10. The method according to claim 9, wherein the two or more rails are secured to the two or more cross member supports via spot welding or bolts and nuts.

11. The method according to claim 10, wherein the mating assembly further comprises multiple gussets for securing the two or more rails to the two or more cross member supports.

12. The method according to claim 1, wherein the mating assembly is attached to the container after the container has been transported from the first location to the second location.

13. The method according to claim 1, wherein the roll-off truck comprises a system for loading, transporting, and unloading the transportable container and the mating assembly, and further comprising activating the system to load, transport, or unload the transportable container.

14. The method according to claim 13, wherein the system utilizes two or more hoist frames located on the roll-off truck that matingly engage with the two or more rails of the mating assembly.

15. The method according to claim 14, wherein the loading assembly is secured to the two or more rails or secured to the two or more rails and the front wall of the container.

16. The method according to claim 15, wherein the loading assembly comprises a hook plate, a hook, and two front rollers.

17. The method according to claim 16, wherein the system is a cable/winch system.

18. The method according to claim 17, wherein activation of the cable/winch system comprises:
attaching a hook of the roll-off truck to the hook of the loading assembly; and
activating a hydraulic system of the roll-off truck to load, transport, or unload the transportable container.

19. The method according to claim 13, wherein the system is a hook/lift system, wherein the loading assembly comprises a frame and a cross bar spanning between two parts of the frame, and wherein the frame is attached to the two or more rails and the front wall of the container.

20. The method according to claim 19, wherein activation of the hook/lift system comprises:
attaching a hook of the roll-off truck to the cross bar of the loading assembly; and
activating a hydraulic system of the roll-off truck to load, transport, or unload the transportable container.
